(19) United States
(12) Patent Application Publication
(10) Pub. No.: US 2025/0103284 A1
(43) Pub. Date: Mar. 27, 2025

(54) ELECTRONIC DEVICE AND METHOD TO REDUCE POWER CONSUMPTION DURING ACCESS

(71) Applicant: MEDIATEK INC., Hsinchu City (TW)

(72) Inventors: Ming-Hung HSIEH, Hsinchu City (TW); Pei-Lun WU, Hsinchu City (TW); Hsin-Yu CHANG, Hsinchu City (TW); Yu-Cheng WU, Hsinchu City (TW)

(21) Appl. No.: 18/883,815

(22) Filed: Sep. 12, 2024

Related U.S. Application Data
(60) Provisional application No. 63/584,513, filed on Sep. 22, 2023.

(51) Int. Cl. G06F 5/16; G06F 1/3234; G06F 13/16

(52) U.S. Cl. CPC G06F 5/16; G06F 1/3253; G06F 13/16

(57) ABSTRACT

An electronic device includes a first buffer, a second buffer, and a multiplexer. The first buffer receives and stores first data when the first buffer is not full, and performs a First-In-First-Out (FIFO) operation on the first data. The second buffer receives and stores second data when the first buffer is full, and performs the FIFO operation on the second data. The multiplexer is electrically connected between the first buffer and the second buffer. The multiplexer receives the first data from outside of the electronic device, or it receives the second data from the second buffer. A depth of the first buffer is less than that of the second buffer.

### CROSS REFERENCE TO RELATED APPLICATIONS

This Application claims priority of U.S. Patent Application No. 63/584,513, filed on Sep. 22, 2023, the entirety of which are incorporated by reference herein.

### BACKGROUND OF THE INVENTION

### Field of the Invention

The present invention relates to an electronic device, and, in particular, to an electronic device and a method to reduce power consumption during access.

### Description of the Related Art

First-In-First-Out buffers (FIFOs) are commonly used in IC design. However, they are often larger than necessary, leading to increased power consumption due to unnecessary toggling of layers. How to design low-power FIFOs or a low power static random-access memory (SRAM) has become an important issue.

### BRIEF SUMMARY OF THE INVENTION

An embodiment of the present invention provides an electronic device. The electronic device includes a first buffer, a second buffer, and a first multiplexer. The first buffer receives and stores first data when the first buffer is not full, and performs a First-In-First-Out (FIFO) operation on the first data. The second buffer receives and stores second data when the first buffer is full, and performs the FIFO operation on the second data. The first multiplexer is electrically connected between the first buffer and the second buffer. The first multiplexer receives the first data from outside of the electronic device, or it receives the second data from the second buffer. A depth of the first buffer is less than that of the second buffer

According to the electronic device described above, when the first buffer is full, the first data is read out from the first buffer, and the second data are present in the second buffer, the first buffer receives the second data from the second buffer through the first multiplexer.

The electronic device further includes a second multiplexer. The second multiplexer is electrically connected to the second buffer. The second multiplexer outputs the second data from outside of the electronic device to the second buffer when the first buffer is full. The second multiplexer outputs a binary zero to the second buffer when the first buffer is not full.

According to the electronic device described above, after the first data are read from the first buffer, the first multiplexer receives the second data from the second buffer and outputs the second data to the first buffer.

According to the electronic device described above, when the first buffer is not full, the second buffer receives a control signal to stop a clock signal in the second buffer.

According to the electronic device described above, the first buffer includes one or more Ultra-Low-Voltage-Threshold (ULVT) cells.

According to the electronic device described above, when the first buffer is not full, the first multiplexer receives the first data from outside of the electronic device, and outputs the first data to the first buffer.

According to the electronic device described above, the second buffer includes a memory unit and a data selecting unit. The memory unit stores the second data when the first buffer is full. The data selecting unit selects the second data based on the FIFO operation, and outputs the second data to the first multiplexer when the first buffer is full.

According to the electronic device described above, the first buffer receives a control signal to stop a clock signal in the first buffer.

According to the electronic device described above, when the depth of the first buffer is larger than 1, the first buffer includes a data selecting unit. The data selecting unit selects the first data based on the FIFO operation, and outputs the first data when the first data is read out.

An embodiment of the present invention also provides a method to reduce power consumption of an electronic device. The electronic device includes a first buffer, a second buffer, and a first multiplexer. The first multiplexer is electrically connected between the first buffer and the second buffer. The method includes the following steps. The first buffer receives and stores first data when the first buffer is not full. The first buffer performs a First-In-First-Out (FIFO) operation on the first data. The second buffer receives and stores second data when the first buffer is full. The second buffer performs the FIFO operation on the second data. The first multiplexer receives and outputs the second data from the second buffer to the first buffer after the first data are read from the first buffer.

According to the method described above, the electronic device includes a second multiplexer electrically connected to the second buffer. The method further includes the following steps. The second multiplexer outputs the second data from outside of the electronic device to the second buffer when the first buffer is full. The second multiplexer outputs a binary zero to the second buffer when the first buffer is not full.

The method further includes the following step. The second buffer receives a control signal to stop a clock signal in the second buffer when the first buffer is not full.

The method further includes the following step. The first multiplexer receives the first data from outside of the electronic device and outputs the first data to the first buffer when the first buffer is not full.

According to the method described above, the depth of the first buffer is less than that of the second buffer.

### BRIEF DESCRIPTION OF THE DRAWINGS

The present invention can be more fully understood by reading the subsequent detailed description and examples with references made to the accompanying drawings, wherein:

FIG. 1 shows a schematic diagram of an electronic device 100 in accordance with some embodiments of the present invention;

FIG. 2 shows a schematic diagram of an electronic device 200 in accordance with some embodiments of the present invention;

FIG. 3 shows a flow chart of a method to reduce power consumption of the electronic device 100 in FIG. 1 and the electronic device 200 in FIG. 2 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

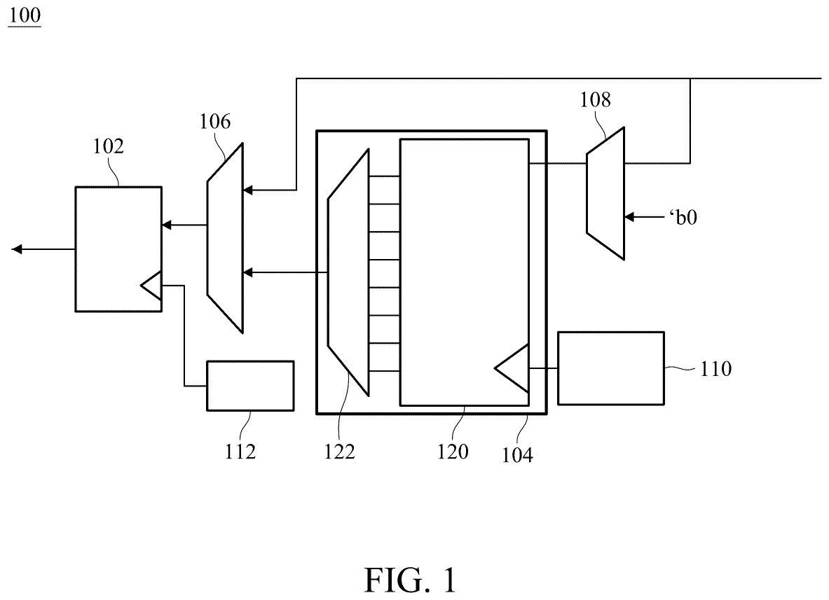

FIG. 1 shows a schematic diagram of an electronic device 100 in accordance with some embodiments of the present invention. As shown in FIG. 1, the electronic device 100 includes a first buffer 102, a second buffer 104, a first multiplexer 106, and a second multiplexer 108. The electronic device 100 may be disposed in any consumer electronics, such as desktop, laptop, tablet, smart phone, and smart watch, but the present invention is not limited thereto. The first multiplexer 106 is electrically connected between the first buffer 102 and the second buffer 104. In some embodiments, the depth of the first buffer 102 is less than that of the second buffer 104. For example, the first buffer 102 may have one or two layers, and the second buffer 104 may have four or five layers, but the present invention is not limited thereto.

In some embodiments, the first buffer 102 receives and stores first data when the first buffer 102 is not full, and performs a First-In-First-Out (FIFO) operation on the first data. That is, the first buffer 102 may be a FIFO buffer. In some embodiments, the first buffer 102 may include one or more Ultra-Low-Voltage-Threshold (ULVT) cells, but the present invention is not limited thereto. Since the first buffer 102 may include one or more ULVT cells, the transmission speed of the ULVT cell is high, and the logic structure of the first buffer 102 is simpler, so that the processing timing can be improved. In some embodiments, the first buffer 102 receives a control signal 112 to stop a clock signal in the first buffer 102. That is, when the first buffer 102 receives the control signal 112, the first buffer 102 is turned off. However, in some embodiments of FIG. 1, the first buffer 102 may never be turned off.

The second buffer 104 receives and stores second data when the first buffer is full, and performs the FIFO operation on the second data. In some embodiments, a time point when the first buffer 102 receives the first data is earlier than a time point when the second buffer 104 receives the second data. That is, the second buffer 104 receives the second data only when the first buffer 102 is full. The first multiplexer 106 receives the first data from outside of the electronic device 100 or receives the second data from the second buffer 104.

In detail, when the first buffer 102 is not full, the first multiplexer 106 receives the first data from outside of the electronic device 100, and outputs the first data to the first buffer 102. After the first data are read from the first buffer 102, the first multiplexer 106 receives the second data from the second buffer 104 and outputs the second data to the first buffer 102. In some embodiments, the first data from outside of the electronic device 100 may be the data from any components that are able to send out the data outside the electronic device 100.

In some embodiments, the second multiplexer 108 is electrically connected to the second buffer 104. The second multiplexer 108 outputs the second data from outside of the electronic device 100 to the second buffer 104 when the first buffer 102 is full. The second multiplexer 108 outputs a binary zero to the second buffer 104 when the first buffer 102 is not full. In some embodiments, the second buffer 104 includes a memory unit 120 and a data selecting unit 122. The memory unit 120 stores the second data from the second multiplexer 108 when the first buffer 102 is full. The data selecting unit 122 selects the second data based on the FIFO operation, and outputs the second data to the first multiplexer 106 when the first buffer 102 is full. In some embodiments, when the depth of the first buffer 102 is larger than 1, the first buffer 102 receives and stores the first data when the first buffer 102 is not full, and performs the FIFO operation on the first data. In some embodiments, when the depth of the first buffer 102 is larger than 1, the first buffer 102 includes a data selecting unit. The data selecting unit selects the first data based on the FIFO operation, and outputs the first data when the first data is read out. It is noted that the first data and the second data are not the data received in sequence. The first data is received by the first buffer 102 when the first buffer 102 is not full. The second data are received by the second buffer 104 when the first buffer 102 is full.

In some embodiments, when the first buffer 102 is not full, the second buffer 104 receives a control signal 110 to stop a clock signal in the second buffer 104. That is, when the second buffer 104 receives the control signal 110, the second buffer 104 is turned off, so that power consumption of the electronic device 100 can be reduced. In some embodiments, the second buffer 104 may be a FIFO buffer. In some embodiments, the second data from outside of the electronic device 100 may be the data from any components that are able to send out the data outside the electronic device 100.

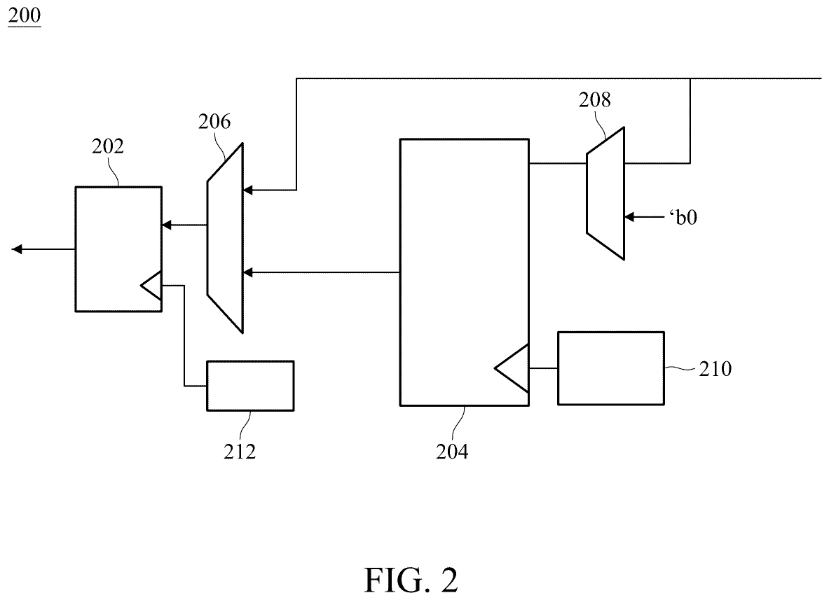

FIG. 2 shows a schematic diagram of an electronic device 200 in accordance with some embodiments of the present invention. As shown in FIG. 2, the electronic device 200 includes a first buffer 202, a second buffer 204, a first multiplexer 206, and a second multiplexer 208. The electronic device 200 may be disposed in any consumer electronics, such as desktop, laptop, tablet, smart phone, and smart watch, but the present invention is not limited thereto. The first multiplexer 206 is electrically connected between the first buffer 202 and the second buffer 204.

In some embodiments, the first buffer 202 receives and stores first data when the first buffer 202 is not full, and performs the FIFO operation on the first data. In some embodiments, the first buffer 202 receives a control signal 212 to stop a clock signal in the first buffer 202. That is, when the first buffer 202 receives the control signal 212, the first buffer 202 is turned off. However, in some embodiments of FIG. 2, the first buffer 202 may never be turned off.

The second buffer 204 receives and stores second data when the first buffer 202 is full, and performs the FIFO operation on the second data. In some embodiments, a time point when the first buffer 202 receives the first data is earlier than a time point when the second buffer 204 receives the second data. That is, the second buffer 204 receives the second data only when the first buffer 202 is full. The first multiplexer 206 receives the first data from outside of the electronic device 200 or receives the second data from the second buffer 204.

In detail, when the first buffer 202 is not full, the first multiplexer 206 receives the first data from outside of the electronic device 200, and outputs the first data to the first buffer 202. After the first data are read from the first buffer 202, the first multiplexer 206 receives the second data from the second buffer 204 and outputs the second data to the first buffer 202. In some embodiments, the first data from outside of the electronic device 200 may be the data from any components that are able to send out the data outside the electronic device 200.

In some embodiments, the second multiplexer 208 is electrically connected to the second buffer 204. The second multiplexer 208 outputs the second data from outside of the electronic device 200 to the second buffer 204 when the first buffer 202 is full. The second multiplexer 208 outputs a binary zero to the second buffer 204 when the first buffer 202 is not full. In some embodiments, when the first buffer 202 is not full, the second buffer 204 receives a control signal 210 to stop a clock signal in the second buffer 204. That is, when the second buffer 204 receives the control signal 210, the second buffer 204 is turned off, so that power consumption of the electronic device 200 can be reduced. In some embodiments, the first buffer 202 and the second buffer 204 may be SRAMs. In some embodiments, the second data from outside of the electronic device 200 may be the data from any components that are able to send out the data outside the electronic device 200.

In some embodiments, it is assumed that the depth of the first buffer 102 is M, and the depth of the second buffer 104 is N, wherein M and N are positive integers, and M is less than N. Thus, the electronic device 100 may replace an original FIFO with the depth of M+N. Users can set the depth of the first buffer 102 based on their needs, such as the number of commonly used FIFO layers. The first buffer 102 toggles normally, while the second buffer 104 toggles only when the data amount exceeds the depth of the first buffer 102. This results in power savings since fewer layers of FIFO need to toggle during simulation. The second buffer 104 is disabled most of the time.

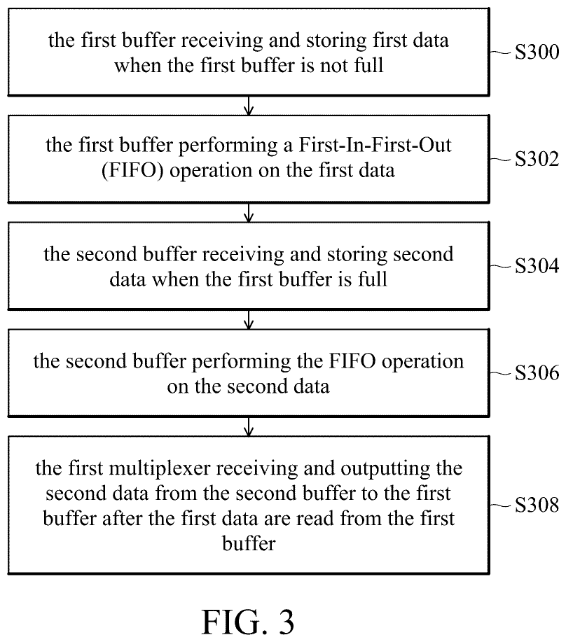

FIG. 3 shows a flow chart of a method to reduce power consumption of the electronic device 100 in FIG. 1 and the electronic device 200 in FIG. 2 in accordance with some embodiments of the present invention. The method to reduce power consumption is applied to the electronic device 100 in FIG. 1 and the electronic device 200 in FIG. 2. As shown in FIG. 3, the method includes the following steps. The first buffer (for example, the first buffer 102 in FIG. 1 or the first buffer 202 in FIG. 2) receives and stores first data when the first buffer is not full (step S300). The first buffer performs the FIFO operation on the first data (step S302). The second buffer (for example, the second buffer 104 in FIG. 1 or the second buffer 204 in FIG. 2) receives and stores second data when the first buffer is full (step S304). The second buffer performs the FIFO operation on the second data (step S306). The first multiplexer (for example, the first multiplexer 106 in FIG. 1 or the first multiplexer 206 in FIG. 2) receives and outputs the second data from the second buffer to the first buffer after the first data are read from the first buffer (step S308). In some embodiments, the first buffer 102 in FIG. 1 may be a FIFO, and the first buffer 202 may be an SRAM. Similarly, the second buffer 104 in FIG. 1 may be a FIFO, and the second buffer 204 may be an SRAM. In some embodiments, when the first buffer is full, the first data is read out from the first buffer, and the second data are present in the second buffer, the first buffer receives the second data from the second buffer through the first multiplexer.

In some embodiments, the method further includes the following steps. The second multiplexer (for example, the second multiplexer 108 in FIG. 1 or the second multiplexer 208 in FIG. 2) outputs the second data from outside of the electronic device to the second buffer when the first buffer is full. The second multiplexer outputs a binary zero to the second buffer when the first buffer is not full. The second buffer receives a control signal (for example, the control signal 110 in FIG. 1 and the control signal 210 in FIG. 2) to stop a clock signal in the second buffer when the first buffer is not full. The first multiplexer receives the first data from outside of the electronic device and outputs the first data to the first buffer when the first buffer is not full.

The electronic devices 100 offer a solution by reducing power consumption and improving timing while still providing enough depth for special circumstances. The electronic devices 100 are designed to minimize unnecessary toggling of layers, resulting in significant power savings. This is particularly important when the actual data processing does not require a large FIFO size. In some embodiments, since the power consumption of ULVT cells may be high, the electronic device 100 has less ULVT cells than the prior art, the power consumption of the electronic device 100 may be reduced.

In addition to power savings, the electronic devices 100 also offer the advantage of reserving enough depth to handle unexpected situations. While the FIFO size may be larger than needed in typical cases, the additional depth can be valuable when there is a sudden surge in data or processing delays.

By using the electronic devices 100, designers can effectively reduce power consumption and ensure sufficient depth for various scenarios. Striking the right balance between power saving and the reserved FIFO depth is crucial for optimizing IC design. The electronic devices 100 provide a practical solution for reducing power consumption in IC design. They offer power savings, improved processing timing, and enough depth for special circumstances. By considering the specific requirements of their designs, users can make informed decisions to achieve the desired balance between power saving and the reserved FIFO depth.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a first buffer, configured to receive and store first data when the first buffer is not full, and to perform a First-In-First-Out (FIFO) operation on the first data;
a second buffer, configured to receive and store second data when the first buffer is full, and to perform the FIFO operation on the second data;
a first multiplexer, electrically connected between the first buffer and the second buffer, configured to receive the first data from outside of the electronic device or to receive the second data from the second buffer,
wherein a depth of the first buffer is less than that of the second buffer.

2. The electronic device as claimed in claim 1, wherein when the first buffer is full, the first data is read out from the first buffer, and the second data are present in the second buffer, the first buffer receives the second data from the second buffer through the first multiplexer.

3. The electronic device as claimed in claim 1, further comprising:
a second multiplexer, electrically connected to the second buffer, configured to output the second data from outside of the electronic device to the second buffer when the first buffer is full, and output a binary zero to the second buffer when the first buffer is not full.

4. The electronic device as claimed in claim 1, wherein after the first data are read from the first buffer, the first multiplexer receives the second data from the second buffer and outputs the second data to the first buffer.

5. The electronic device as claimed in claim 1, wherein when the first buffer is not full, the second buffer receives a control signal to stop a clock signal in the second buffer.

6. The electronic device as claimed in claim 1, wherein the first buffer comprises one or more Ultra-Low-Voltage-Threshold (ULVT) cell.

7. The electronic device as claimed in claim 1, wherein when the first buffer is not full, the first multiplexer receives the first data from outside of the electronic device, and outputs the first data to the first buffer.

8. The electronic device as claimed in claim 1, wherein the second buffer comprises:
a memory unit, configured to store the second data when the first buffer is full; and
a data selecting unit, configured to select the second data based on the FIFO operation, and output the second data to the first multiplexer when the first buffer is full.

9. The electronic device as claimed in claim 1, wherein the first buffer receives a control signal to stop a clock signal in the first buffer.

10. The electronic device as claimed in claim 1, wherein when the depth of the first buffer is larger than 1, the first buffer comprises a data selecting unit; the data selecting unit selects the first data based on the FIFO operation, and outputs the first data when the first data is read out.

11. A method to reduce power consumption of an electronic device, wherein the electronic device comprises a first buffer, a second buffer, and a first multiplexer, and the first multiplexer is electrically connected between the first buffer and the second buffer, the method comprising:
the first buffer receiving and storing first data when the first buffer is not full;
the first buffer performing a First-In-First-Out (FIFO) operation on the first data;
the second buffer receiving and storing second data when the first buffer is full;
the second buffer performing the FIFO operation on the second data; and
the first multiplexer receiving and outputting the second data from the second buffer to the first buffer after the first data are read from the first buffer.

12. The method as claimed in claim 11, wherein the electronic device comprises a second multiplexer electrically connected to the second buffer, the method further comprising:
the second multiplexer outputting the second data from outside of the electronic device to the second buffer when the first buffer is full; and
the second multiplexer outputting a binary zero to the second buffer when the first buffer is not full.

13. The method as claimed in claim 11, further comprising:
the second buffer receiving a control signal to stop a clock signal in the second buffer when the first buffer is not full.

14. The method as claimed in claim 11, further comprising:
the first multiplexer receiving the first data from outside of the electronic device and outputting the first data to the first buffer when the first buffer is not full.

15. The method as claimed in claim 11, wherein the depth of the first buffer is less than that of the second buffer.
